(19) United States
(12) Patent Application Publication
(10) Pub. No.: US 2024/0376960 A1
(43) Pub. Date: Nov. 14, 2024

(54) CRANKSHAFT DAMPER

(71) Applicant: APROTECH POWERTRAIN LLC, Asheville, NC (US)

(72) Inventor: Scott K. THOMPSON, Asheville, NC (US)

(21) Appl. No.: 18/657,391

(22) Filed: May 7, 2024

Related U.S. Application Data
(60) Provisional application No. 63/464,863, filed on May 8, 2023.

(51) Int. Cl. F16F 15/126

(52) U.S. Cl. CPC F16F 15/126

(57) ABSTRACT

A dual shear disk crankshaft damper having an inertia ring includes a disk, an elastomeric ring receives the outer portion of the disk, an inertia ring defines an annular recess disposed on a first radially extending side of the elastomeric ring, and a cup that includes an annular radially extending leg and an annular axially extending leg. The cup includes a rim that is received in the annular recess. In an alternative embodiment, a dual shear disk crankshaft damper includes a first inertia ring and a second inertia ring, an elastomeric ring, first and second inertia rings, and a tubular case disposed on a radially outer surface of the elastomeric ring and a radially outer surface of the first and second inertia rings.

### REFERENCE TO RELATED APPLICATIONS

This application claims the benefit of U.S. provisional application Ser. No. 63/464,863 filed May 8, 2023, the disclosure of which is hereby incorporated in its entirety by reference herein.

### TECHNICAL FIELD

This disclosure relates to an engine crankshaft damper for engines operating at high temperatures.

### BACKGROUND

Crankshaft dampers are used to reduce torsional deflections in crankshafts of combustion engines. Crankshaft dampers function by converting torsional deflections into heat which reduces the crankshaft torsional deflections to increase the life of a crankshaft. Crankshaft dampers may be of the elastomeric type or of the viscous fluid type. This disclosure is directed to elastomeric type crankshaft dampers.

Crankshaft dampers are typically attached to the front end of the engine and are normally enclosed in confined spaces. Heat from the engine and other components such as turbochargers, and the like, creates high ambient temperatures in the engine compartment. Heat is also conducted from the engine to the crankshaft damper. The high ambient temperatures and heat conducted by the engine add to the heat created by damping the torsional deflections of the crankshaft.

Elastomeric crankshaft dampers generally include a rigid hub that is secured to the crankshaft. An inertia ring is attached to the hub by an elastomeric member which may be shaped as a ring or a disk. Vibrations of the crankshaft are damped by torsional shearing of the elastomeric member relative to the inertia ring. The inertia of the inertia ring and the torsional spring rate of the elastomeric member are selected to provide a specific natural frequency, at which resonance occurs resulting in maximum heat generation in the crankshaft damper to minimize crankshaft deflection.

All crankshaft dampers, including both viscous and elastomeric crankshaft dampers, have operating temperature limits based on their design and the temperature resistance of the damping materials. Recently released high temperature crankshaft damper elastomers have a higher temperature limit than other types of crankshaft damper elastomers and viscous fluids. However, some applications may exceed the temperature limit of these high temperature crankshaft damper elastomers and, as a result, there is a need for improvements in elastomeric crankshaft dampers to obtain greater heat dissipation.

This disclosure is directed to solving the above problems and other problems as summarized below.

### SUMMARY

According to one aspect of this disclosure, a dual shear disk crankshaft damper having an inertia ring is disclosed that comprises a disk defining a central opening and having an outer portion that extends radially inwardly from a periphery of the disk. An elastomeric ring defines a slot that receives the outer portion of the disk. The inertia ring is disposed on a first radially extending side of the elastomeric ring that defines an annular recess at a circumferentially extending radially outer periphery of the inertia ring. A cup includes an annular radially extending leg and an annular axially extending leg, The annular radially extending leg is disposed on a second radially extending side of the elastomeric ring that faces away from the first radially extending side of the elastomeric ring. The cup includes a rim that is received in the annular recess.

According to other alternative and optional aspects of this disclosure may include that the cup compresses elastomeric ring. The dual shear crankshaft disk damper may further comprise a plurality of radially extending grooves provided on an outer side of the inertia ring facing away from the first radially extending side of the elastomeric ring. The inertia ring may extend radially inwardly relative to an inner diameter of the elastomeric ring. The cup may have a radially extending leg extending radially inwardly from an inner diameter of the elastomeric ring.

The dual shear crankshaft disk damper may further comprise a plurality of cooling channels that extend radially from an inner diameter of the inertia ring through the inertia ring that open into a plurality of openings in the case. The cooling channels may be oblong in shape. The openings in the cup may be circular. Alternatively, a second disk may be provided between the elastomeric ring and the inertia ring. The inertia ring may have cooling channels that are arcuate in shape. The cooling channels may have an open side facing the first radially extending side of the elastomeric ring, and wherein the second disk covers the open side of the channels.

The elastomeric ring may define a plurality of V-shaped notches at an inner diameter of the elastomeric ring with the widest end of the V-shaped notches being provided at the inner diameter of the elastomeric ring.

According to another aspect of this disclosure, a dual shear crankshaft disk damper having a first inertia ring and a second inertia ring is disclosed that includes a disk defining a central opening that has an outer portion that extends radially inwardly from a periphery of the disk. An elastomeric ring defining a slot that receives the outer portion of the disk. The first inertia ring disposed on a first radially extending side of the elastomeric ring. The first inertia ring has a first annular recess defined at a circumferentially extending radially outer periphery of the first inertia ring on a first side facing away from the elastomeric ring, and the second inertia ring disposed on a second radially extending side of the elastomeric ring. The second inertia ring has a second annular recess defined at a circumferentially extending radially outer periphery of the second inertia ring on a second side facing away from the elastomeric ring. A case having a tubular shape is disposed on a radially outer surface of the elastomeric ring and a radially outer surface of the first inertia ring. The case includes a first rim received in the first annular recess and a second rim received in the second annular recess.

According to other alternative and optional aspects of this disclosure as it relates to a crankshaft damper having a first inertia ring and a second inertia ring, the elastomeric ring generates heat transferred directly by contact between the radially outer surface of the elastomeric ring to the case. In addition, heat generated by the elastomeric ring is transferred directly from the radially outer surface of the elastomeric ring to the case, and wherein heat is transferred directly by contact from the elastomeric ring to the first inertial ring and the second inertial ring.

The dual shear crankshaft disk damper may further comprise a first inertia ring extension and second inertia ring extension that extend radially inwardly relative to an ID of the elastomeric ring.

The dual shear crankshaft disk damper may further comprise a plurality of cooling channels that extend radially from an inner diameter of the first inertia ring radially through the first inertia ring and that open into a plurality of openings in the case. The cooling channels may be oblong in shape. The openings in the case may be circular. The dual shear crankshaft disk damper may further comprise a second disk disposed between the elastomeric ring and the first inertia ring, wherein the inertia ring has cooling channels that are arcuate in shape, the cooling channels have an open side facing the first radially extending side of the elastomeric ring, and wherein the second disk covers the open side of the channels.

The elastomeric ring defines a plurality of V-shaped notches at an inner diameter of the elastomeric ring with a widest end of the V-shaped notches being provided at the inner diameter of the elastomeric ring.

These and other aspects of this disclosure are disclosed with reference to the attached drawings as described below.

### BRIEF DESCRIPTION OF THE DRAWINGS

FIG. 1 is a perspective view partially cut away of one embodiment of a dual shear crankshaft damper.

FIG. 2 is a partial elevation view of the dual shear crankshaft damper shown in FIG. 1.

FIG. 3 is a cross section view of a portion of the dual shear crankshaft damper shown in FIG. 1.

FIG. 4 is a perspective view partially cut away of a second embodiment of a dual shear crankshaft damper.

FIG. 5 is a partial elevation view of the dual shear crankshaft damper shown in FIG. 4.

FIG. 6 is a cross section view of a portion of the dual shear crankshaft damper shown in FIG. 4.

FIG. 7 is a perspective view partially cut away of a third embodiment of a dual shear crankshaft damper.

FIG. 8 is a partial elevation view of the dual shear crankshaft damper shown in FIG. 7.

FIG. 9 is a cross section view of a portion of the dual shear crankshaft damper shown in FIG. 7.

FIG. 10 is a perspective view partially cut away of a fourth embodiment of a dual shear crankshaft damper.

FIG. 11 is a partial elevation view of the dual shear crankshaft damper shown in FIG. 10.

FIG. 12 is a cross section view of a portion of the dual shear crankshaft damper shown in FIG. 10.

FIG. 13 is a perspective view partially cut away of a fifth embodiment of a dual shear crankshaft damper.

FIG. 14 is a partial elevation view of the dual shear crankshaft damper shown in FIG. 13.

FIG. 15 is a cross section view of a portion of the dual shear crankshaft damper shown in FIG. 13.

FIG. 16 is a side elevation view partially cut away of a dual shear crankshaft damper shown in FIG. 13.

FIG. 17 is a perspective view partially in cross section of the elastomeric ring with V-shaped notches at an inner diameter of the elastomeric ring with a widest end of the V-shaped notches being provided at the inner diameter of the elastomeric ring.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Reference will now be made in detail to embodiments, examples of which are illustrated in the accompanying drawings. In the following detailed description, numerous specific details are set forth to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

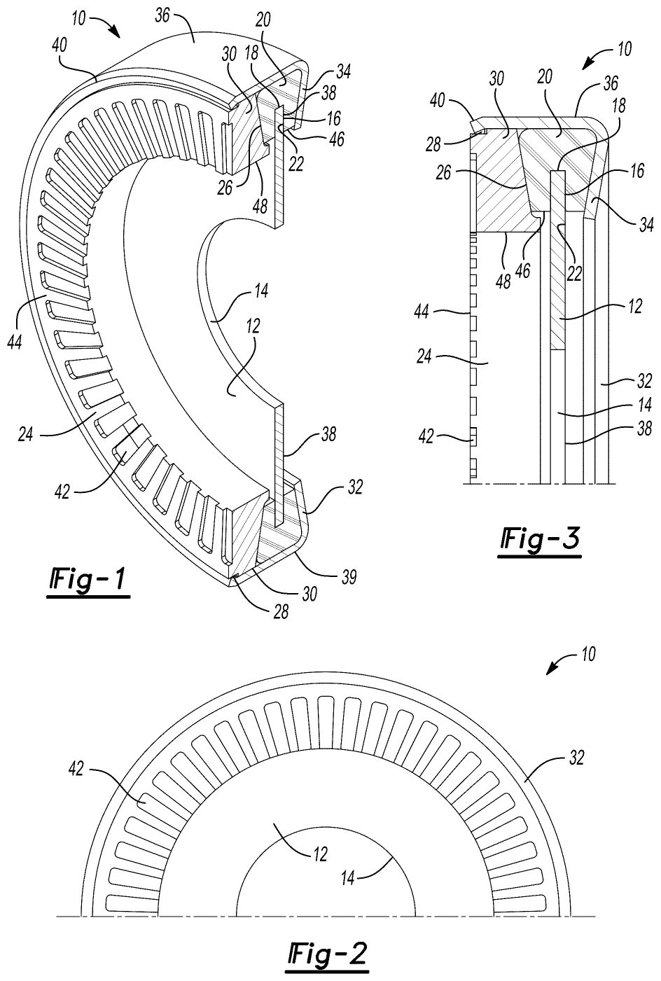

Referring to FIGS. 1-3, a dual shear disc crankshaft damper 10 is disclosed that includes a disk 12 that defines a central opening 14. Central opening 14 is adapted to receive a crankshaft of an engine (not shown). The disk 12 includes an outer portion 16 that extends radially inwardly from a periphery 18 of the disk 12.

A U-shaped elastomeric ring 20 defines a slot 22 that receives the outer portion 16 of the disk 12. The U-shaped elastomeric ring 20 is formed by extruding an elastomeric strip forming a straight U-channel. The straight U-channel is wrapped around the disk 12. Alternatively, the U-shaped elastomeric ring 20 that defines the slot 22 may be referred to as a U-channel strip that can be molded instead of being extruded. The U-channel can be formed as a ring that is bonded to the disk 12 or can be molded onto the disk 12 in an insert mold.

In contrast, prior dual shear dampers included two disks of elastomer disposed on opposite sides of the disk 12. To successfully wrap the disk 12 without buckling or folding, the height of the legs, the shape of the legs (whether straight, tapered, or having a rounded outer surface) and the incorporation of molded notches that close when wrapped around the disk 12. A limited amount of buckling of the elastomeric ring 20 may be overcome after the disk 12 with the elastomeric ring 20 wrapped around the disk 12 is assembled into the damper 10. Axial compression applied during assembly of the cup 32 or case 70 (as described below) causes the buckling to relax.

An inertia ring 24 is assembled to a first side 26 of the elastomeric ring 20. An annular recess 28 is provided on the inertia ring 24 at an outer periphery 30 of the inertia ring 24.

A cup 32 includes a radially extending leg 34 and an axially extending leg 36. The radially extending leg 34 of the cup 32 is disposed on a second side 38 of the elastomeric ring 20. The radially extending leg 34 extends across the outer surface 39 of the elastomeric ring 20 and the outer periphery 30 of the inertia ring 24. Heat generated by the elastomeric ring 20 is transferred directly to the radially extending leg 34, the axially extending leg 36, and the inertia ring 24 that are in direct contact with the cup 32.

A rim 40 is provided on the distal end of the axially extending leg 36. The rim 40 is formed into the annular recess 28 defined by the inertia ring 24. The rim 40 secures the cup 32 to the elastomeric ring 20 and the inertia ring 24. A press may be used to compress the cup 32 and form the rim 40 into the annular recess 28.

A plurality of radially extending grooves 42 are provided on the outer side 44 of the inertia ring 24. The grooves 42 create turbulence on the side of the inertia ring 24 to cool the inertia rings 52 and 60.

The elastomeric ring 20 has an inner diameter 46 that is recessed relative to an inner diameter 48 of the inertia ring 24. Extending the inertia ring 24 to a location inboard of the elastomeric ring 20 increases the mass of the inertia ring 24.

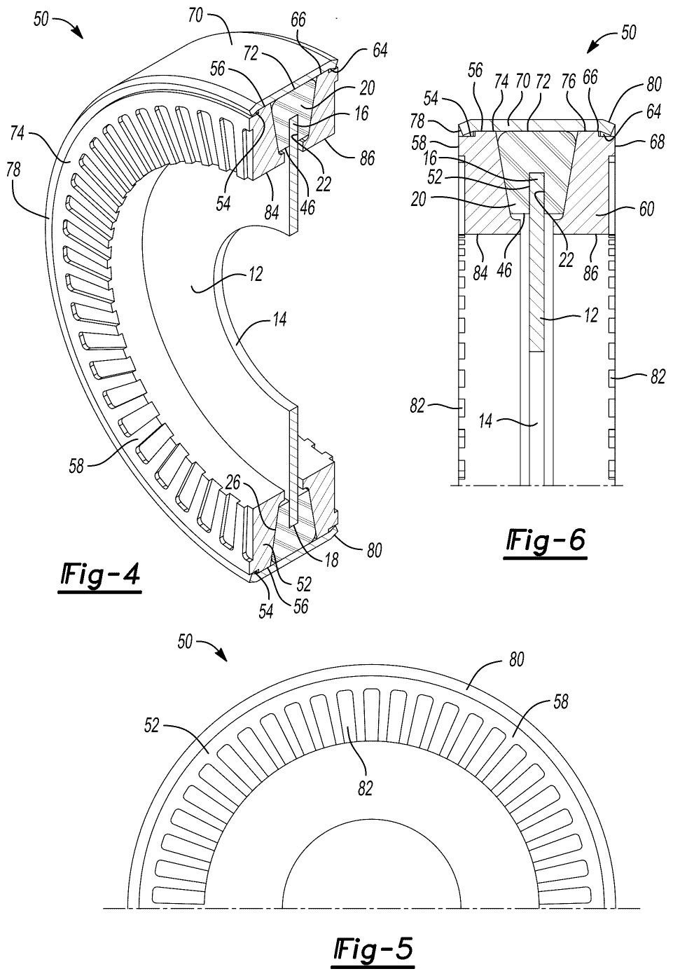

Referring to FIGS. 4-6, an alternative embodiment of a dual shear disk crankshaft damper 50 is illustrated. Similar components to the components of the embodiment disclosed with reference to FIGS. 1-3 are referenced with the same reference numerals.

The dual shear crankshaft disk damper 50 comprises a disk 12 defining a central opening 14 that includes an outer portion 16 that extends radially inwardly from a periphery 18 of the disk 12. An elastomeric ring 20 defines a slot 22 that receives the outer portion 16 of the disk 12. A first inertia ring 52 is disposed on a first radially extending side 26 of the elastomeric ring 20. The radially extending side 26 is not strictly radially extending but increases in width and is beveled outwardly in an axial direction. The first inertia ring 52 has a first annular recess 54 defined at a circumferentially extending radially outer periphery 56 of the first inertia ring 52 on a first side 58 facing away from the elastomeric ring 20. A second inertia ring 60 is disposed on a second radially extending side 62 of the elastomeric ring 20. The second inertia ring 60 has a second annular recess 64 defined at a circumferentially extending radially outer periphery 66 of the second inertia ring 60 on a second side 68 facing away from the elastomeric ring 20. A case 70 having a tubular shape is disposed on an outer periphery 56 of the elastomeric ring 20 and an outer periphery 74 of the first inertia ring 52 and an outer periphery 76 of the second inertia ring 66. The case 70 includes a first rim 78 received in the first annular recess 54 and a second rim 80 received in the second annular recess 64.

The case 70 is generally tubular in shape that extends in the axial direction and is centered relative to the axis of rotation of the crankshaft. The case 70 extends across the outer surface 72 of the elastomeric ring 20, the outer periphery 56 of the first inertia ring 52, and the outer periphery 66 of the second inertia ring 60. Heat generated by the elastomeric ring 20 is transferred directly to the case 70 and to the inertia rings 52 and 60 that are in direct contact with the case 70.

A first rim 78 and a second rim 80 are provided on the opposite ends of the case 70. The rims 78 and 80 are formed into the first annular recess 54 and the second annual recess 64 defined by the first inertia ring 52 and the second inertia ring 60, respectively. The rims 78 and 80 secure the case 70 to the elastomeric ring 20 and the inertia ring 24. A press is used to compress the case 70 and form the first rim 78 and the second rim 80 into the first annular recess 54 and the second annular recess 64, respectively.

A plurality of radially extending grooves 82 are provided on the outer surface 34 of the inertia ring 52. The grooves 82 create turbulence on the sides of the first inertia ring 52 and the second inertia ring 60 and are provided to facilitate cooling the inertia rings 52 and 60.

The elastomeric ring 20 has an inner diameter 46 that is recessed relative to an inner diameter 84 of the first inertia ring 52 and an inner diameter 86 of the second inertia ring 60. Extending the inertia rings 52 and 60 to a location radially inboard of the elastomeric ring 20 increases the mass of the inertia rings 52 and 60.

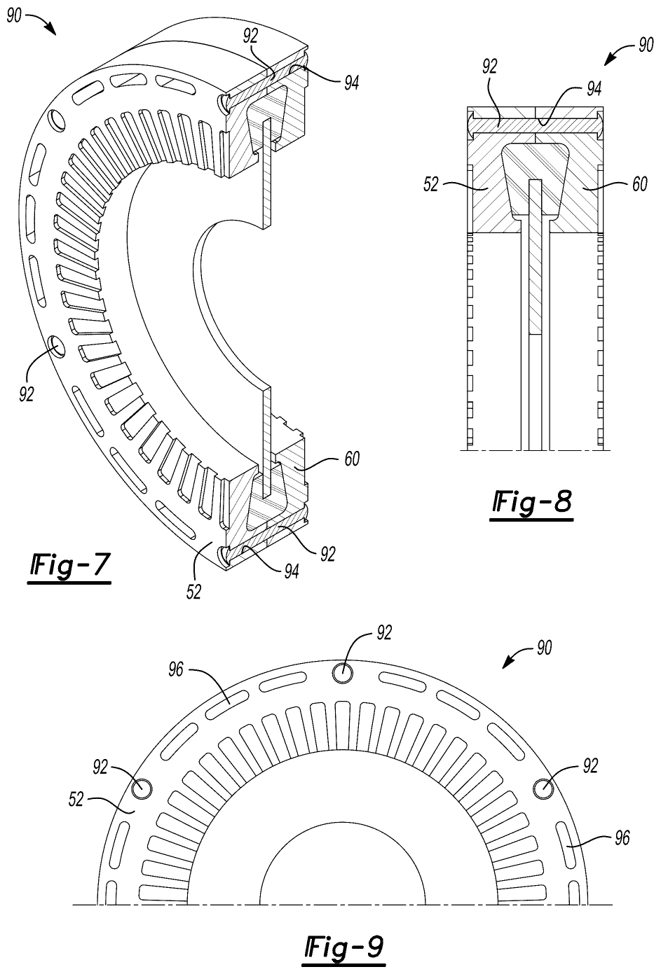

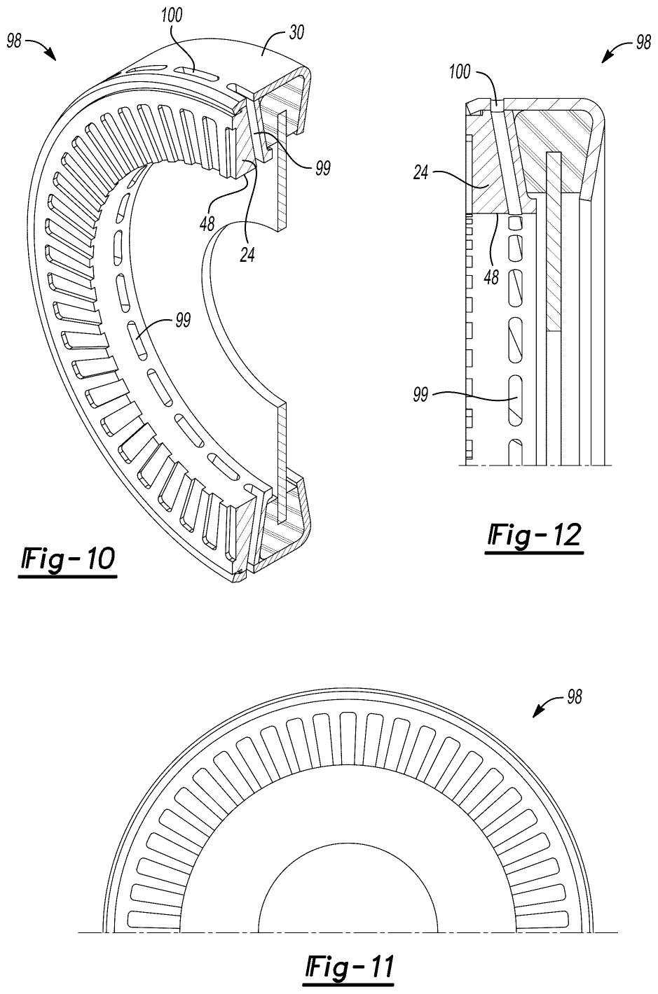

Referring to FIGS. 7-9, another alternative embodiment of a dual shear crankshaft disk damper 90 is illustrated that includes all of the elements of the embodiment of FIGS. 4-6. The disclosure of FIGS. 4-6 are incorporated by reference herein and for brevity will not be repeated in the description of FIGS. 7-9.

One element added to the dual shear crankshaft disk damper 90 include rivets 92 for assembling the first inertia ring 52 and the second inertia ring 60 together instead of securing them together with a case 70 (shown in FIGS. 4-6). The rivets 92 are received in openings 94 formed in the first inertia ring 52 and the second inertia ring 60.

Another feature added to the dual shear crankshaft disk damper 90 include a plurality of cooling openings 96 formed in the first inertia ring 52 and the second inertia ring 60. The cooling openings 96 are arcuate in shape and extend through both the first inertia ring 52 and the second inertia ring 60. Air circulates through the cooling openings 96 between the front side and the back side of the dual shear crankshaft disk damper 90.

Referring to FIGS. 10-12, another alternative embodiment of a dual shear crankshaft disk damper 98 is illustrated that includes all of the elements of the embodiment of FIGS. 1-3. The disclosure of FIGS. 1-3 are incorporated by reference herein and for brevity will not be repeated in the description of FIGS. 10-12.

The dual shear crankshaft disk damper 98 adds cooling channels 99 that extend from the inner diameter 48 of the inertia ring 24 to the outer periphery 30 of the cup 32. The cooling channels 99 are racetrack shaped. The cooling channels are provided to allow air to circulate from the inner diameter 48 of the inertia ring 24 to the outer periphery 30 of the cup 32. The cup 32 in the embodiment of FIGS. 10-12 includes a plurality of holes 100 that open into the cooling channels 99 of the inertia ring 20 through which air can flow. The cooling channels 99 are formed by cores (not shown) inserted in the casting mold used to cast the inertia ring 24.

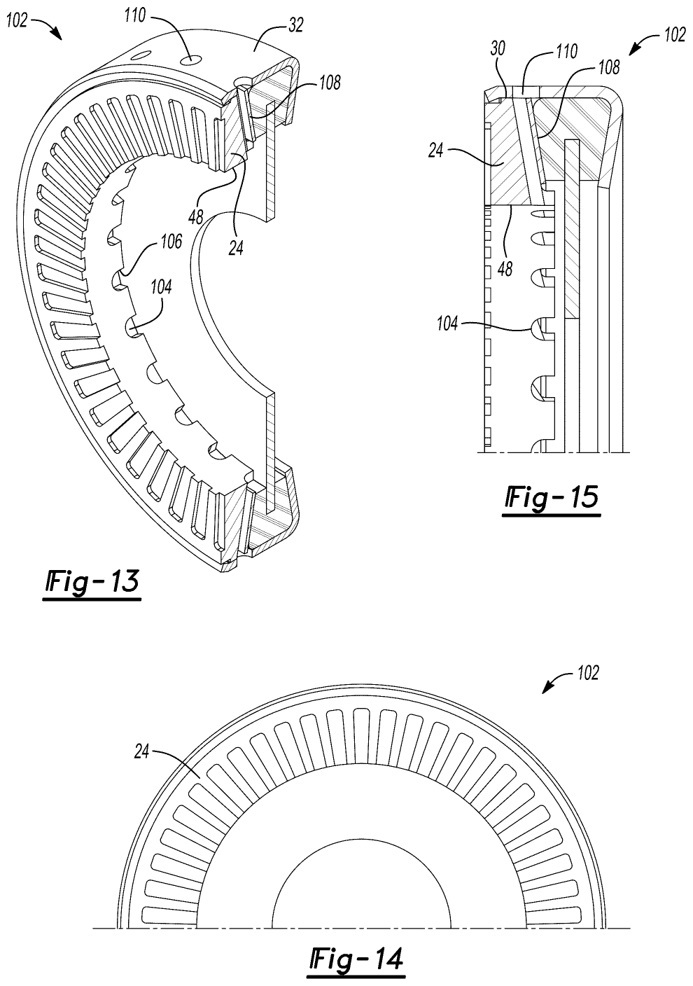

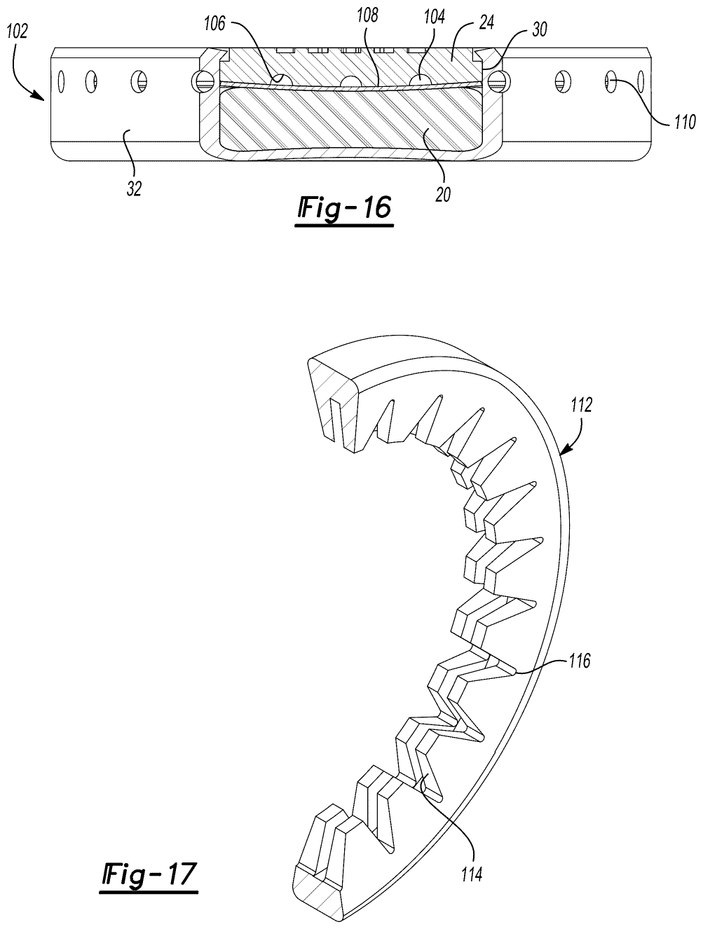

Referring to FIGS. 13-16, another alternative embodiment of a dual shear crankshaft disk damper 102 is illustrated that includes all the elements of the embodiment of FIGS. 1-3. The disclosure of FIGS. 1-3 are incorporated by reference herein and for brevity will not be repeated in the description of FIGS. 10-12.

The dual shear crankshaft disk damper 102 adds cooling channels 104 that extend from the inner diameter 48 of the inertia ring 24 to the outer periphery 30 thereof. The cooling channels 104 are generally U-shaped and are formed by grooves 106 that are either cast or machined in the inertia ring 24. A beveled disk 108, or beveled washer or shim, is assembled over the open end of the U-shaped grooves to cover the grooves 106 and form the cooling channels 104. The cup 32 in the embodiment of FIGS. 13-16 includes a plurality of holes 110 that open into the cooling channels 104 of the inertia ring 20 allowing air to flow therethrough.

The beveled disk 108 provides a consistent, relatively smooth surface that is bonded to the elastomeric ring 20 to eliminate stress concentrations in the elastomeric ring 20. The beveled disk 108 is made of steel or a polymer that efficiently conducts heat from the elastomeric ring 20 to the cooling channels 104. One advantage of this construction is that the grooves 106 can be cast or machined into the inertia ring 24 instead of casting the inertia ring 24 with cores that must be removed after casting.

Referring to FIG. 17, an alternative elastomeric ring 112 is illustrated that includes V-shaped notches 114 on the inner diameter of the elastomeric ring. The V-shaped notches 114 are wider at the inner diameter and narrow in the radially outer portion of the elastomeric ring 20 to a point. 116. The notches 116 inhibit buckling of the elastomeric ring 20 and allows a higher delta temperature between the OD and the ID of the elastomeric ring 112.

“One or more” includes a function being performed by one element, a function being performed by more than one element, e.g., in a distributed fashion, several functions being performed by one element, several functions being performed by several elements, or any combination of the above. The features of various implementing embodiments may be combined to form further embodiments of the invention.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A dual shear disk crankshaft damper, comprising:
a disk defining a central opening and having an outer portion that extends radially inwardly from a periphery of the disk;
an elastomeric ring defining a slot that receives the outer portion of the disk;
an inertia ring disposed on a first radially extending side of the elastomeric ring, the inertia ring having an annular recess defined at a circumferentially extending radially outer periphery of the inertia ring; and
a cup including an annular radially extending leg and an annular axially extending leg, wherein the annular radially extending leg is disposed on a second radially extending side of the elastomeric ring that faces away from the first radially extending side of the elastomeric ring, and wherein the cup includes a rim that is received in the annular recess.

2. The dual shear crankshaft disk damper of claim 1 wherein the cup compresses elastomeric ring.

3. The dual shear crankshaft disk damper of claim 1 further comprising:
a plurality of radially extending grooves provided on an outer side of the inertia ring facing away from the first radially extending side of the elastomeric ring.

4. The dual shear crankshaft disk damper of claim 1 wherein the inertia ring extends radially inwardly relative to an inner diameter of the elastomeric ring.

5. The dual shear crankshaft disk damper of claim 1 wherein the cup has a radially extending leg extending radially inwardly from an inner diameter of the elastomeric ring.

6. The dual shear crankshaft disk damper of claim 1 further comprising:
a plurality of cooling channels that extend radially from an inner diameter of the inertia ring through the inertia ring that open into a plurality of openings in the case.

7. The dual shear crankshaft disk damper of claim 6 wherein the cooling channels are oblong in shape.

8. The dual shear crankshaft disk damper of claim 6 wherein the openings in the cup are circular.

9. The dual shear crankshaft disk damper of claim 1 further comprising:
a second disk disposed between the elastomeric ring and the inertia ring, wherein the inertia ring has cooling channels that are arcuate in shape, the cooling channels have an open side facing the first radially extending side of the elastomeric ring, and wherein the second disk covers the open side of the channels.

10. The dual shear crankshaft disk damper of claim 1, wherein the elastomeric ring defines a plurality of V-shaped notches at an inner diameter of the elastomeric ring with the widest end of the V-shaped notches being provided at the inner diameter of the elastomeric ring.

11. A dual shear crankshaft disk damper, comprising:
a disk defining a central opening and having an outer portion that extends radially inwardly from a periphery of the disk;
an elastomeric ring defining a slot that receives the outer portion of the disk;
a first inertia ring disposed on a first radially extending side of the elastomeric ring, wherein the first inertia ring has a first annular recess defined at a circumferentially extending radially outer periphery of the first inertia ring on a first side facing away from the elastomeric ring;
a second inertia ring disposed on a second radially extending side of the elastomeric ring, wherein the second inertia ring has a second annular recess defined at a circumferentially extending radially outer periphery of the second inertia ring on a second side facing away from the elastomeric ring; and
a case having a tubular shape disposed on a radially outer surface of the elastomeric ring and a radially outer surface of the first inertia ring and a radially outer surface of the second inertia ring, wherein the case includes a first rim received in the first annular recess and a second rim received in the second annular recess.

12. The dual shear crankshaft disk damper of claim 11 wherein the elastomeric ring generates heat transferred directly by contact between the radially outer surface of the elastomeric ring to the case.

13. The dual shear crankshaft disk damper of claim 11 heat generated by the elastomeric ring is transferred directly from the radially outer surface of the elastomeric ring to the case, and wherein heat is transferred directly by contact from the elastomeric ring to the first and second inertial rings.

14. The dual shear crankshaft disk damper of claim 11 further comprising:
a first inertia ring extension and second inertia ring extension extend radially inwardly relative to an ID of the elastomeric ring.

15. The dual shear crankshaft disk damper of claim 11 further comprising:
a plurality of cooling channels that extend radially from an inner diameter of the first inertia ring radially through the first inertia ring and that open into a plurality of openings in the case.

16. The dual shear crankshaft disk damper of claim 15 wherein the cooling channels are oblong in shape.

17. The dual shear crankshaft disk damper of claim 15 wherein the openings in the case are circular.

18. The dual shear crankshaft disk damper of claim 15 further comprising:
a second disk disposed between the elastomeric ring and the first inertia ring, wherein the inertia ring has cooling channels that are arcuate in shape, the cooling channels have an open side facing the first radially extending side of the elastomeric ring, and wherein the second disk covers the open side of the channels.

19. The dual shear crankshaft disk damper of claim 11, wherein the elastomeric ring defines a plurality of V-shaped notches at an inner diameter of the elastomeric ring with a widest end of the V-shaped notches being provided at the inner diameter of the elastomeric ring.
